(19) United States
(12) Patent Application Publication
(10) Pub. No.: US 2014/0284445 A1
(43) Pub. Date: Sep. 25, 2014

(54) METHOD, SYSTEM, AND DEVICE FOR MANIPULATING A DETACHABLE OBJECT MOUNTED WITH UNRESTRICTED VIEWING FIELD

(71) Applicants: Felix Gorohovsky, Fort Lee, NJ (US); Gregory Raskin, Solon, OH (US); Leonid Khodor, Orange, OH (US)

(72) Inventors: Felix Gorohovsky, Fort Lee, NJ (US); Gregory Raskin, Solon, OH (US); Leonid Khodor, Orange, OH (US)

(21) Appl. No.: 13/848,756

(22) Filed: Mar. 22, 2013

(51) Int. Cl. F16M 13/02

(52) U.S. Cl. CPC F16M 13/022
USPC 248/550; 248/329; 248/324

(57) ABSTRACT

A method, system, and device for manipulating of surveillance cameras and the like mounted on top of utility poles. The system comprises: a multi-link articulating mechanism connected to a base, having a distal end, and configured to change positions of said distal end between over the base and cantilevered beyond the base; an object support connected to at least two links of the mechanism and configured to rotate from upright position with the distal end being over the base to upside down position with the distal end being cantilevered beyond the base; a winch mounted to the object support having a cable extended through said object support and configured for attaching the detachable object; and control means configured to manipulate the detachable object between being mounted upright and hanged by the cable at a predetermined height.

### BACKGROUND OF THE INVENTION

The present invention relates to manipulating of detachable objects mounted at top edges of high structures and, more particularly, to manipulating of surveillance cameras and the like mounted on top of utility poles, masts, and towers that provides improved features and capabilities.

Various objects requiring more or less regular and, sometimes, emergency maintenance are frequently installed at heights inaccessible without specialized equipment and/or specially trained workers. For example, surveillance cameras, lighting and signaling devices, as well as certain communication devices need to be placed at a significant elevation to perform their functions properly. Their maintenance, due to a use of specialized mobile platforms, necessitates a paved access in remote areas and causes traffic restrictions in built up areas.

A partial solution to this problem is provided by hanging the object from a housing attached to a stationary arm cantilevered from the structure. In this arrangement, the object is attached to the housing with a cable and a latching mechanism, which includes a power/data connector and an orienting means. Typically, a female part of the connector and stationary part of the latching mechanism belong to the housing with a male part of the connector and removable parts of the latching mechanism are installed onto the object.

The latching mechanism engages/disengages by pulling the cable that can be attached to a winch for lowering and rising the object. Generally, the cable reaches through the housing and the arm to the winch normally concealed at the structure base. Due to difficulties in controlling the pull forces while operating the latching mechanism, the cable has to be of greater size than otherwise required by the object parameters.

An obvious shortcoming associated with this solution is a restricted viewing field. A blind zone angle is a function of a size of the structure and the length of the arm. While a restriction caused by a short arm is more severe, a long arm requires heavier structure for its support as a tradeoff for decreasing the restriction. That necessitates an installation and, in some cases, synchronization of additional objects to cover the restricted area.

Therefore, there is a need for a solution that provides an ability to lower the objects having unrestricted viewing field to the ground level for maintenance. It would be desirable to shorten the cable and decrease a number of bends as well as total bend angle between the object and the winch. Additionally, it would be desirable to decrease the cable size that would be beneficial for overall size and weight of the mounting device. Further, such device should preferably be controlled remotely.

### SUMMARY OF THE INVENTION

The present invention generally focuses on improved functionality and serviceability of surveillance cameras and the like mounted on top of utility poles, masts, and towers, specifically on providing unrestricted viewing field coupled with the ability to lower the camera to the ground level for maintenance. Particularly, in its various embodiments and implementations, the invention facilitates higher efficiency by providing, for example, a surveillance camera at a particular installation with the highest possible elevation and unobstructed view. Furthermore, the present invention provides for simplified and lower cost maintenance by excluding a necessity of using specialized mobile equipment and/or specially trained workers. Moreover, in its various embodiments and implementations, the invention provides for reducing indirect costs associated with having to utilize specialized mobile platforms like paved accesses, permits from cities to close/restrict public access to areas around work sites, traffic restrictions, and so on.

In general, in one aspect, a method for manipulating a detachable object mounted with unrestricted viewing field comprises steps of: placing the detachable object in upright position at a certain vertical distance from and horizontally in proximity to an edge, rotating the detachable object unidirectional interdependently around a first axis positioned in proximity to the edge and a second axis positioned in proximity to said detachable object until said detachable object is cantilevered from said edge in upside down position, lowering the detachable object for a predetermined distance, rising the detachable object for the predetermined distance, and rotating the detachable object unidirectional interdependently around said first axis positioned in proximity to the edge and said second axis positioned in proximity to said detachable object until said detachable object returns into the initial position.

Various embodiments and implementations of this aspect of the invention may include that said first and second axes may be horizontal axes, the steps of said rotating the detachable object may comprise a step of sensing at least one predetermined relative to the first axis position, and the steps of said lowering and rising of the detachable object may comprise a step of sensing at least one predetermined relative to the second axis position.

In general, in another aspect, the invention relates to a system for manipulating a detachable object mounted with unrestricted viewing field that comprises: a multi-link articulating mechanism connected to a base, having a distal end, and configured to change positions of said distal end between generally vertical over the base and cantilevered to a certain position beyond the base; an object support connected to at least two links of the multi-link articulating mechanism, the object support configured to rotate from upright position with the distal end being generally vertical over the base to upside down position with the distal end being cantilevered to said certain position beyond the base; a winch mounted to the object support having a cable extended through said object support and configured for attaching the detachable object; and a control means configured to manipulate the detachable object between being mounted with unrestricted viewing field and hanged by the cable at a predetermined height.

Various embodiments and implementations of this aspect of the invention may include a latching mechanism configured to engage corresponding parts of the detachable object, sensors configured to detect at least one of limits of movement of the multi-link articulating mechanism and at least one position of the detachable object relative to the latching mechanism, and a drive, which may be a linear actuator, attached to at least one link of the multi-link articulating mechanism, said drive may be configured to move said multi-link articulating mechanism. The drive may be attached either to two links of the multi-link articulating mechanism or to the base and one of the links of the multi-link articulating mechanism.

In general, in yet another aspect, the invention relates to a device for manipulating a detachable object mounted with unrestricted viewing field that comprises: a frame attached pivotally to a stationary base; an articulating leg comprising joined at a knee pivot a lower leg attached pivotally to said stationary base and an upper leg attached pivotally to said frame; and a hoist attached pivotally to said frame and linked to said articulating leg. Various embodiments and implementations of this aspect of the invention may include the following features:

The hoist may comprise a winch, a nest, and a detachable object support, said detachable object support may be connected to the winch by a cable and may carry detachable parts of a latching mechanism corresponding to stationary parts of said latching mechanism attached to the nest. A linear actuator may be attached pivotally either to said frame and to said articulating leg or to said stationary base and to said articulating leg. Furthermore, the linear actuator may be attached pivotally coaxially with said lower leg to said stationary base and to said upper leg. A position with the detachable object mounted for unrestricted viewing field may correspond to the pivots of the articulating leg located approximately on a straight line. The hoist may be linked to said articulating leg either by a link attached pivotally to said hoist and to said lower leg or by meshed gear segments attached correspondingly to said hoist and to said upper leg. At least one sensor may be configured to detect at least one predetermined position of either said frame or said articulating leg or said detachable object support and at least one sensor may be configured to detect at least one predetermined position of said detachable object support relative to said stationary parts of said latching mechanism.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the invention.

FIG. 1 depicts a perspective view of an embodiment of the device according to present invention with a detachable object positioned for unrestricted viewing field.

FIG. 2 depicts a side view of the embodiment shown in FIG. 1.

FIG. 3 depicts the side view of the embodiment shown in FIG. 1 with the device in an intermittent position.

FIG. 4 depicts the side view of the embodiment shown in FIG. 1 with the device having the detachable object cantilevered.

FIG. 5 depicts the side view of the embodiment shown in FIG. 1 with the device having the detachable object suspended with a cable.

FIG. 6 depicts a perspective view of another embodiment of the device according to present invention with a detachable object positioned for unrestricted viewing field.

FIGS. 7A and 7B depict respectively perspective and side views of the embodiment shown in FIG. 6 with the device in an intermittent position.

FIGS. 8A and 8B depict respectively perspective and side views of the embodiment shown in FIG. 6 with the device having the detachable object cantilevered.

FIG. 9 depicts the side view of the embodiment shown in FIG. 6 with the device having the detachable object suspended with a cable.

### DETAILED DESCRIPTION

The following detailed description is not to be taken in a limiting sense, but is made merely for the purpose of illustrating the general principles of the invention, since the scope of the invention is best defined by the appended claims.

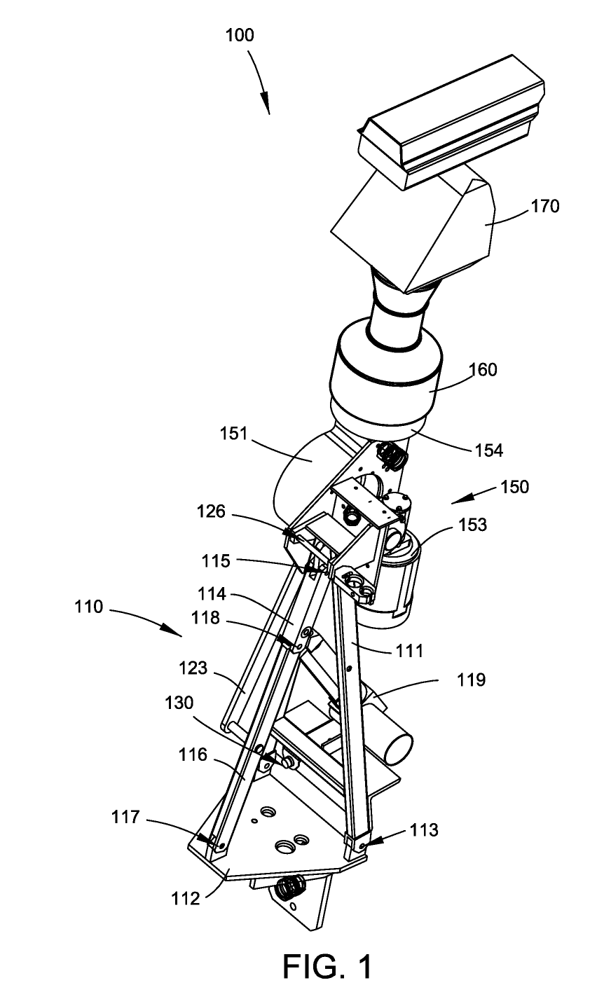

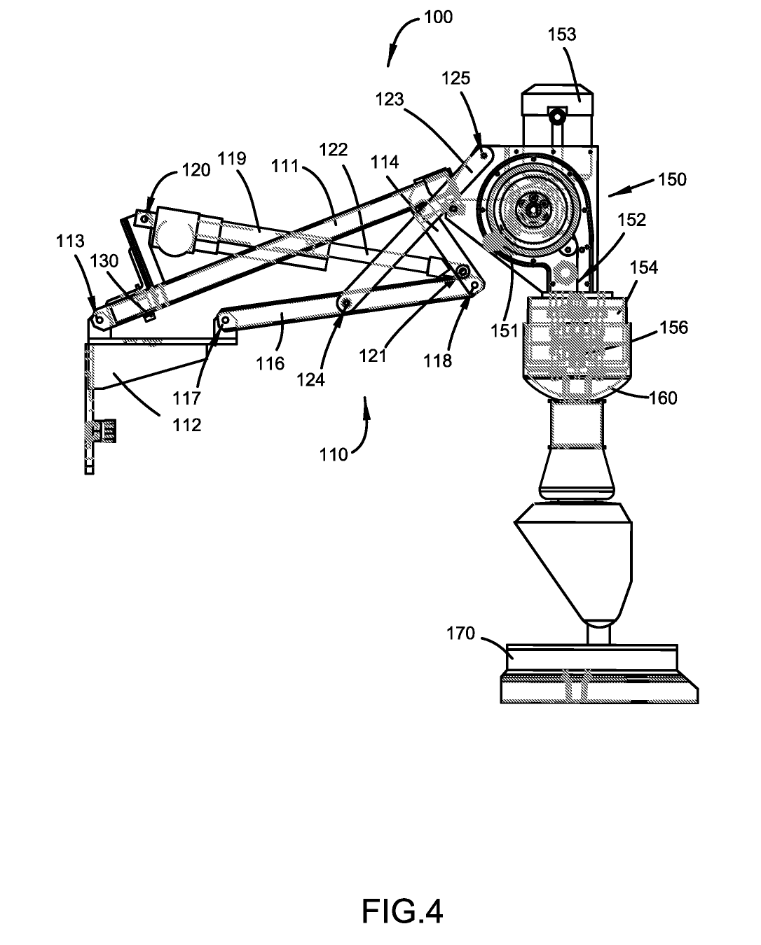

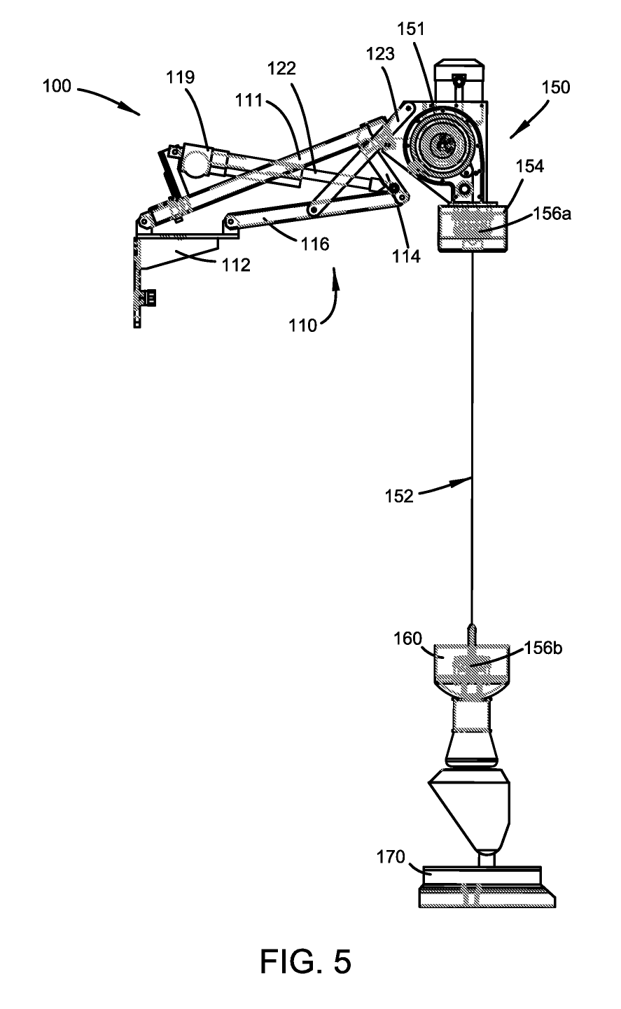

In its various embodiments, the present invention focuses on an improved device for manipulating a detachable object mounted with unrestricted viewing field in general and a device for lowering a surveillance camera and the like mounted upright on top of a utility pole specifically. Referring to FIGS. 1-5, in one embodiment, an articulating tripod 110 of the device 100 may comprise a two legged frame 111 that may be attached to a base 112 with pins 113 and joined to an upper leg 114, with a pivot 115. The base 112 may be configured for fastening to a vertical surface. A lower leg 116 may be attached to the base 112 with a pivot 117 and to the upper leg 114 with a pivot 118. A body 119 of a linear actuator may be connected to the frame 111 by a pivot 120 and its rod 122—to the upper leg 114 by a pivot 121. A link 123 may be connected to the lower leg 116 with a pivot 124 and to a hoist 150 with a pin 125.

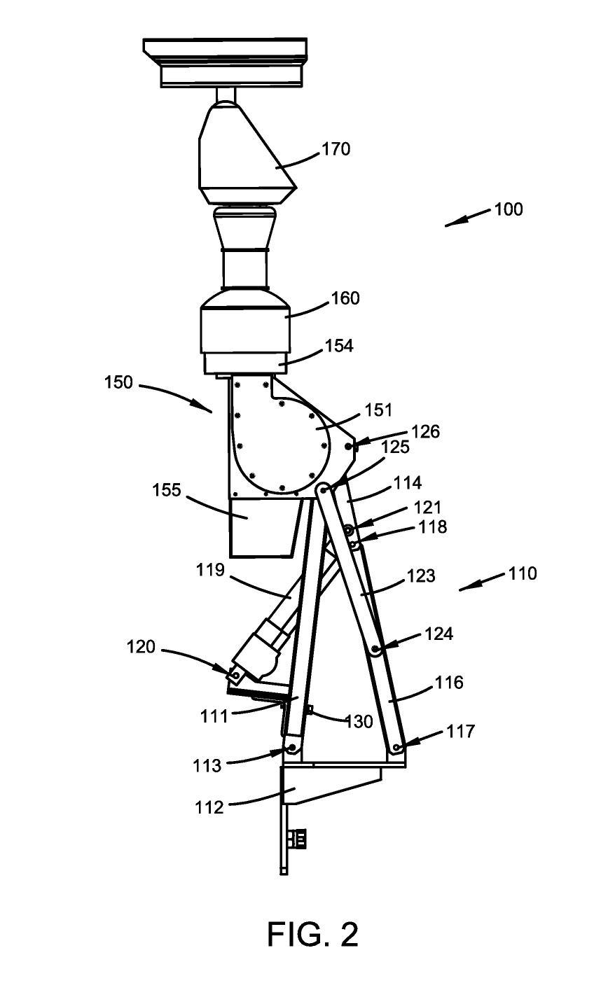

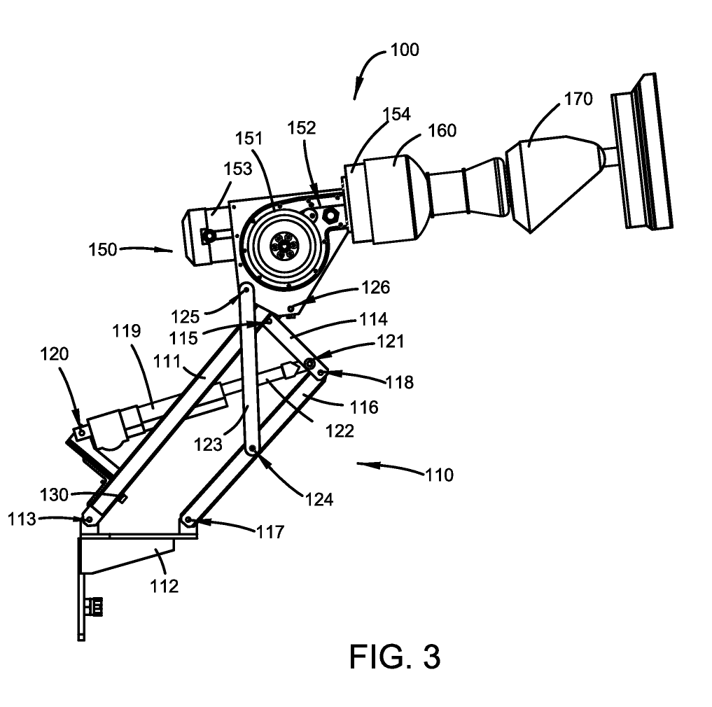

The hoist 150 rotatable on an axle 126 placed at a distal end of the frame 111 may comprise a winch 151 with a cable 152 driven by a gearmotor 153 and a nest 154. The gearmotor 153 may be protected by an enclosure 155 shown only in FIG. 2. As well, for clarity of further descriptions, the winch 151 is shown without a cover in FIGS. 3-5. A latching mechanism 156 and the cable 152 may connect a detachable support 160 with a camera 170 to the nest 154, wherein a stationary part 156a of the latching mechanism 156 may be fastened into the nest 154 and a detachable part 156b may be fastened to the support 160. With the latching mechanism 156 engaged, a seal between the support 160 and the nest 154 may provide an electrical connector incorporated into the latching mechanism 156 with a protection against elements. A sensor 130 may be placed, for example, with the frame 111 while other sensors providing data for controlling the device 100 may be placed anywhere with or within components of the device, for example, the linear actuator body 119 or the latching mechanism 156.

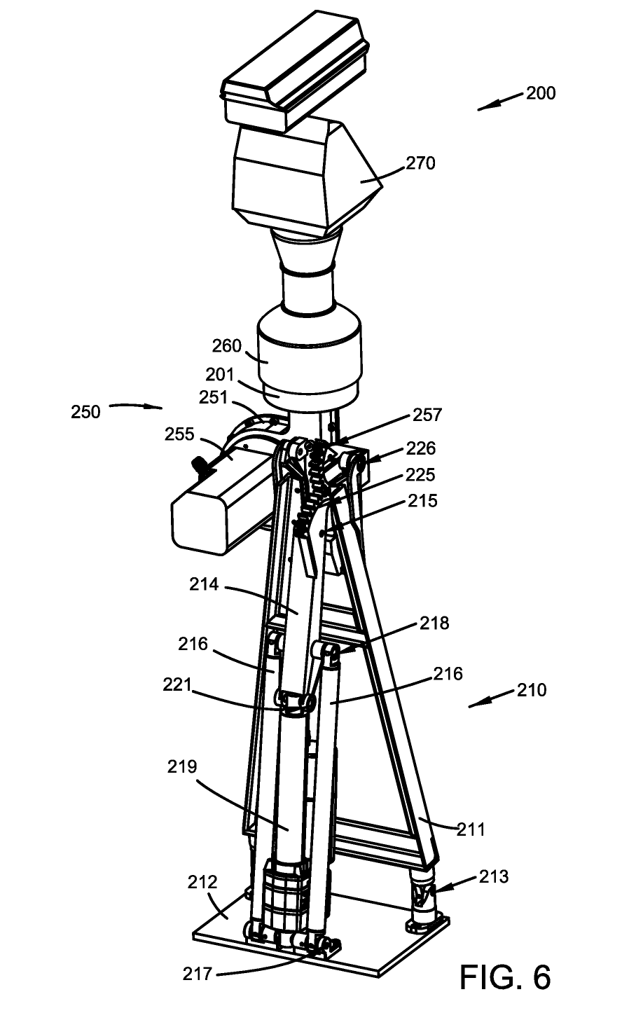

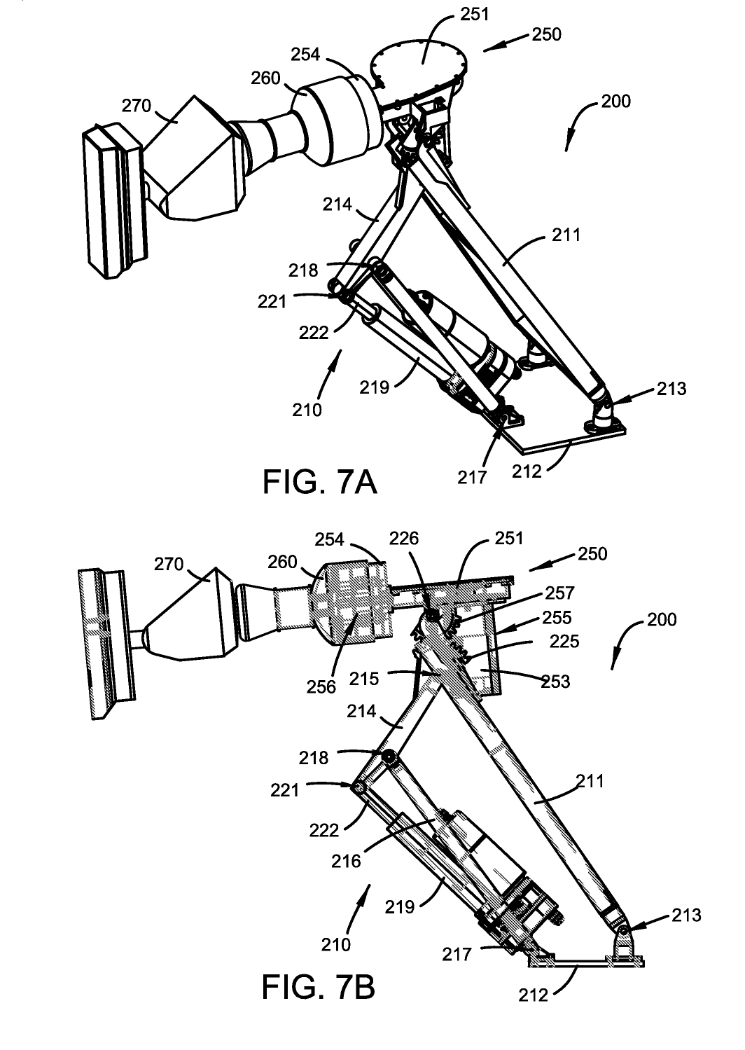

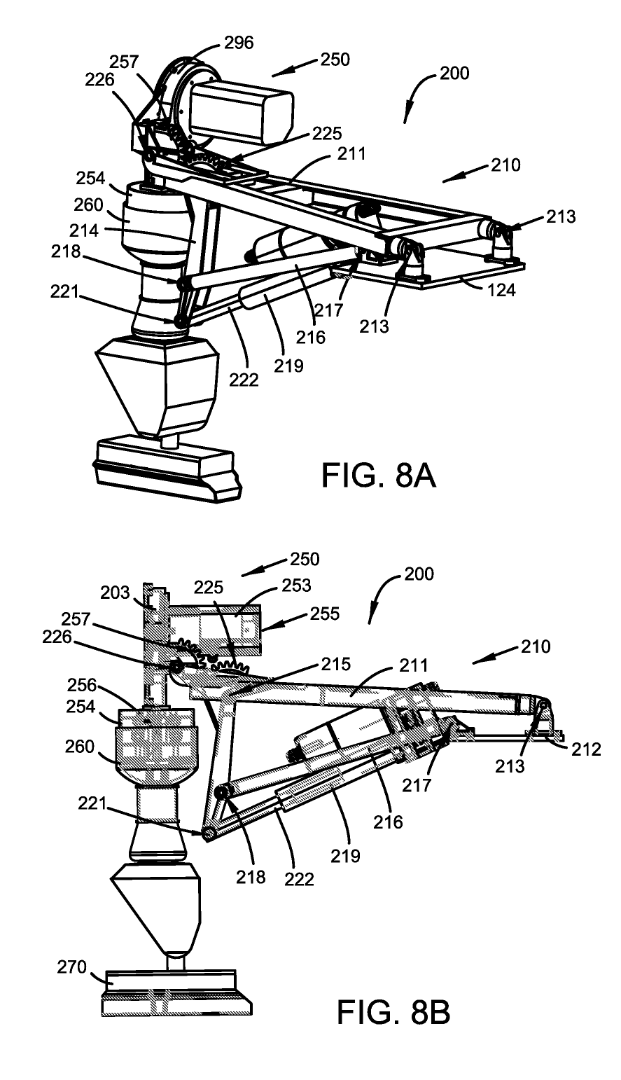

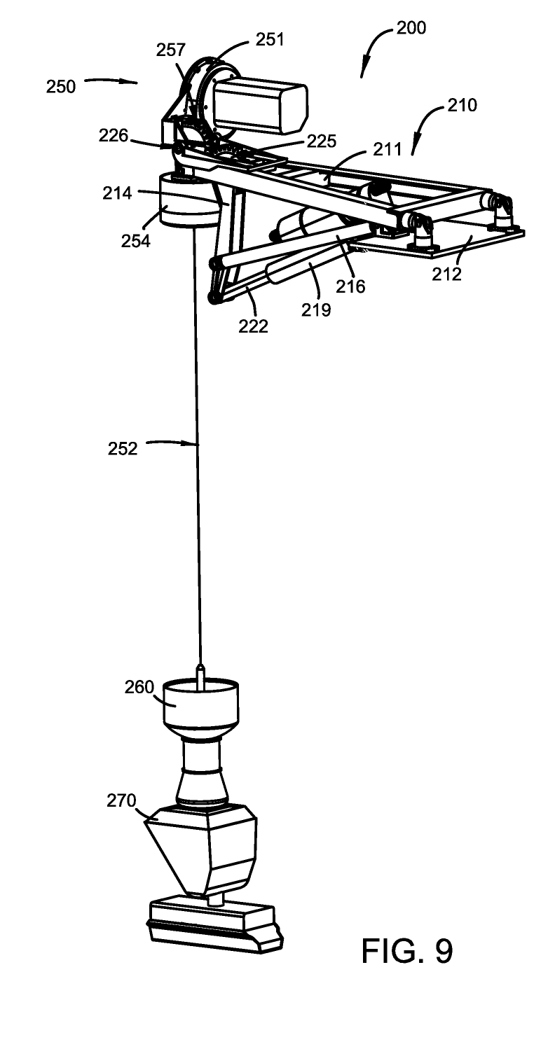

Referring to FIGS. 6-9, in another embodiment, an articulating tripod 210 of the device 200 may comprise a two legged frame 211 that may be attached to a base 212 with pins 213 and joined to an upper leg 214, with a pivot 215. The base 212 may be configured for fastening to a horizontal surface. Two symmetrically positioned lower legs 216 may be attached to the base 212 by a pivot 217 and to the upper leg 214 with a pivot 218. A body 219 of a linear actuator may be pivotally connected to the base 212 coaxially and between the legs 216 by the pivot 217 and its rod 222—to the upper leg 214 by a pivot 221. A gear segment 225 may be fastened to the upper leg 214 and meshed with a pinion segment 257 fastened to a hoist 250.

The hoist 250 rotatable on an axle 226 placed at a distal end of the frame 211 may comprise a winch 251 with a cable 252 driven by a gearmotor 253 and a nest 254. The gearmotor 253 may be placed in an enclosure 255. A latching mechanism 256 and the cable 252 may connect a detachable support 260 with a camera 270 to the nest 254. Sensors providing data for controlling the device 200 may be placed anywhere with or within components of the device, for example, the linear actuator body 219 or the latching mechanism 256. Methods and means of fixing positions of one part relative to another well known in the art so, those of ordinary skill in the art will readily envision a variety of means and/or structures for performing the functions.

The embodiments of the present invention may function as shown in FIGS. 2-5. With the camera 170 in upright (surveillance) position, the rod 122 is retracted and the pivots 115, 117, and 118 are located on a straight line that makes the tripod 110 a rigid pyramid. When the rod 122 extends, it pushes the upper 114 and lower 116 legs and pivot 118 outward that decreases distances between pivots 115,117 and 124, 126. As a result, the frame 111 pulled by the upper leg 114 around the pins 113 and the hoist 150 pushed by the link 123 around the axle 126 are rotated in the same direction until a control system (not shown) receives a signal from the sensor 130 that the hoist 150 is turned upside down.

Then the control system switches the camera 170 off and the winch 151 on. The winch 151 pulls the cable 152 and, after releasing by that the latching mechanism 156, reverses the direction to lower the support 160 with the camera 170 to predetermined height for maintenance. To return the camera 170 back into the upright position, the winch 151 pulls the cable 152 until the latching mechanism 156 engages sufficiently and, after that, reverses for a short time to release the cable 152 from the stress. With the latching mechanism 156 engaged, the rod 122 retracts returning the tripod 110 into initial rigid state with the camera 170 being upright. Determining the latching mechanism 156 state and, correspondingly, limiting the pull force of the cable 152 may be aided by a sensor embedded into the nest 154. Latching mechanisms that include electrical connectors and orienting means are well known in the art.

Referring to FIGS. 6-9, a function of an embodiment of the present invention 200 differs from depicted above in that the hoist 250 is rotated by an interaction of the gear 225 and pinion 257. With the camera 270 in upright (surveillance) position, the rod 222 is retracted and the pivots 215, 217, and 218 are located on a straight line that makes the tripod 210 a rigid pyramid. When the rod 222 extends, it rotates the upper leg 214 clockwise around the pivot 218 that decreases distances between pivots 215 and 217. As a result, the frame 211 is pulled counterclockwise by the upper leg 214 around the pins 213 and the hoist 250 rotated counterclockwise as well by the interaction between the gear segment 225 and the pinion segment 257 around the axle 226 until a control system (not shown) receives a signal from the sensor 230 that the hoist 250 is turned upside down.

Then the control system switches the camera 270 off and the winch 251 on. The winch 251 pulls the cable 252 and, after releasing by that the latching mechanism 256, reverses the direction to lower the support 260 with the camera 270 to predetermined height for maintenance. To return the camera 270 back into the upright position, the winch 251 pulls the cable 252 until the latching mechanism 256 engages sufficiently and, after that, reverses for a short time to release the cable 252 from the stress. With the latching mechanism 256 engaged, the rod 222 retracts returning the tripod 210 into initial rigid state with the camera 270 being upright. Determining the latching mechanism 256 state and, correspondingly, limiting the pull force of the cable 252 may be aided by a sensor embedded into the nest 254.

Considering that a summary of angles of rotation of the frame 111, 211 with the hoist 150, 250 correspondingly equal 180°, a configuration of the device 200 may provide the greater angle for the frame 211 comparing to the frame 111 of the device 100 and, accordingly, the lesser angle for the hoist 250 comparing to the hoist 150.

Consequently, the present invention provides the improved device for manipulating a detachable object mounted with unrestricted viewing field. Furthermore, the invention provides that such device positions the detachable object at the highest possible elevation. Moreover, the present invention provides for decreasing the cable size and length as well as a number of bends and a total bend angle between the object and the winch.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters and configurations described herein are meant to be exemplary and that the actual parameters and/or configurations will depend upon the specific application or applications for which the inventive teachings are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

Accordingly, as indicated above, the foregoing embodiments of the invention are examples and can be varied in many ways. Such present or future variations are not to be regarded as a departure from the spirit and scope of the invention, and all such modifications as would be apparent to one skilled in the art are intended to be included within the scope of the following claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

“Consisting essentially of,” when used in the claims, shall have its ordinary meaning as used in the field of patent law.

As used herein, the term “about” refers to a +/−10% variation from the nominal value. It is to be understood that such a variation is always included in any given value provided herein, whether or not it is specifically referred to.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

We claim:

1. A method for manipulating a detachable object mounted with unrestricted viewing field comprising steps of:
placing the detachable object in upright position at a certain vertical distance from and horizontally in proximity to an edge;
rotating the detachable object unidirectional interdependently around a first axis positioned in proximity to the edge and a second axis positioned in proximity to said detachable object until said detachable object is cantilevered from said edge in upside down position;
lowering the detachable object for a predetermined distance;
rising the detachable object for the predetermined distance; and
rotating the detachable object unidirectional interdependently around said first axis positioned in proximity to the edge and said second axis positioned in proximity to said detachable object until said detachable object returns into the initial position.

2. A method of claim 1, wherein said first and second axes are horizontal axes.

3. A method of claim 1, wherein the steps of said rotating the detachable object include a step of sensing at least one predetermined relative to the first axis position.

4. A method of claim 1, wherein the steps of said lowering and rising of the detachable object include a step of sensing at least one predetermined relative to the second axis position.

5. A system for manipulating a detachable object mounted with unrestricted viewing field comprising:
a multi-link articulating mechanism connected to a base, said multi-link articulating mechanism has a distal end and configured to change positions of said distal end between generally vertical over the base and cantilevered to a certain position beyond the base;
an object support connected to at least two links of the multi-link articulating mechanism, the object support configured to rotate from upright position with the distal end being generally vertical over the base to upside down position with the distal end being cantilevered to said certain position beyond the base;
a winch mounted to the object support having a cable extended through said object support and configured for attaching the detachable object; and
control means configured to manipulate the detachable object between being mounted with unrestricted viewing field and hanged by the cable at a predetermined height.

6. A system of claim 5, wherein said object support comprises a latching mechanism configured to engage corresponding parts of the detachable object.

7. A system of claim 5, further comprising sensors configured to detect at least one of limits of movement of the multi-link articulating mechanism and at least one position of the detachable object relative to the latching mechanism.

8. A system of claim 5, further comprising a drive attached to at least one link of the multi-link articulating mechanism, said drive configured to move said multi-link articulating mechanism.

9. A system of claim 8, wherein said drive is a linear actuator attached to two links of the multi-link articulating mechanism.

10. A system of claim 9, wherein said drive is a linear actuator attached to the base and at least one of the links of the multi-link articulating mechanism.

11. A device for manipulating a detachable object mounted with unrestricted viewing field comprising:
a frame attached pivotally to a stationary base;
an articulating leg comprising joined at a knee pivot a lower leg attached pivotally to said stationary base and an upper leg attached pivotally to said frame; and
a hoist attached pivotally to said frame and linked to said articulating leg;

12. A device of claim 11, wherein the hoist comprises a winch, a nest, and a detachable object support, said detachable object support is connected to the winch by a cable and carries detachable parts of a latching mechanism corresponding to stationary parts of said latching mechanism attached to the nest.

13. A device of claim 12, further comprising at least one sensor configured to detect at least one predetermined position of said detachable object support relative to said stationary parts of said latching mechanism.

14. A device of claim 11, further comprising a linear actuator attached pivotally to said frame and to said articulating leg.

15. A device of claim 11, further comprising a linear actuator attached pivotally to said stationary base and to said articulating leg.

16. A device of claim 11, further comprising a linear actuator attached pivotally coaxially with said lower leg to said stationary base and to said upper leg.

17. A device of claim 11, wherein a position with the detachable object mounted for unrestricted viewing field corresponds to the pivots of the articulating leg located approximately on a straight line.

18. A device of claim 11, wherein said hoist linked to said articulating leg by a link attached pivotally to said hoist and to said lower leg.

19. A device of claim 11, wherein said hoist linked to said articulating leg by meshed gear segments attached correspondingly to said hoist and to said upper leg.

20. A device of claim 11, further comprising at least one sensor configured to detect at least one predetermined position of either said frame or said articulating leg or said detachable object support relative to said stationary base.
